(19) United States
(12) Patent Application Publication
(10) Pub. No.: US 2008/0127497 A1
(43) Pub. Date: Jun. 5, 2008

(54) Blade assembly

(76) Inventors: Dennis Moss, Pittsford, NY (US); Michael D. Moss, Brooklyn, NY (US)

Correspondence Address: HOWARD J. GREENWALD P.C., 349 W. COMMERCIAL STREET SUITE 3075, EAST ROCHESTER, NY, 14445-2408, US

(21) Appl. No.: 11/983,293

(22) Filed: Nov. 8, 2007

Related U.S. Application Data
(63) Continuation-in-part of application No. 11/589,576, filed on Oct. 30, 2006.
Application No. 11/589,576 is a continuation-in-part of application No. 11/263,092, filed on Oct. 31, 2005.

(51) Int. Cl. B26B 3/00; B26B 9/02

(52) U.S. Cl. 30/304; 30/355

(57) ABSTRACT

A blade assembly that contains a first blade and a shield. The shield is comprised of a first sidewall and a second sidewall, wherein the first sidewall has a first top surface and a first bottom surface, and the second sidewall has a second top surface and a second bottom surface. The first blade is comprised of a first proximal end and a first distal end, a first means for bonding the proximal end to the shield, and a second means for bonding the distal end to the shield. The first blade does not extend above the first top surface or the second top surface, and the first blade does not extend below the first bottom surface or the second bottom surface. Each of the ends of the first blade is disposed within and attached to the shield.

### CROSS-REFERENCE TO RELATED PATENT APPLICATIONS

This patent application is a continuation-in-part of applicants' copending patent application Ser. No. 11/589,576, filed on Oct. 30, 2006, which in turn was a continuation-in-part of copending patent application U.S. Ser. No. 11/263,092, filed on Oct. 31, 2005.

### FIELD OF THE INVENTION

A blade assembly comprised of a blade and a frame in which the blade is disposed within, surrounded by, and attached to the frame.

### BACKGROUND OF THE INVENTION

The preparation of food for cooking and eating usually involves cutting food items such as fruit, vegetables, meat, and dough-based products into smaller pieces for cooking or baking, combination with other items, and presentation to the consumer. For food items to be combined as slices with other foods, as in the preparation of bread, rolls, bagels, or other items too thick for eating alone and uncut, the slicing process is time-consuming, sometimes dangerous to the preparer, and often error-prone in that the results of a slicing operation can be uneven, unattractive, or even unusable in producing the final dish. These problems can result in food wastage, injury, and delays in preparation which are unacceptable in most meal preparation processes.

Bagels present unique problems in preparing a sandwich. A bagel sandwich is made by slicing the bagel in half on a plane perpendicular to the axis of the hole in the bagel. Bagels are quite firm and thick, and they present considerable resistance to a cutting blade when being cut. In addition, the outer surface of the bagel is smooth, round, and two-dimensionally convex, making it highly unstable for cutting except when laid flat on a surface and cut horizontally. Horizontal cutting requires more energy and time than downward (vertical) cutting, both to execute the cut and to hold the bagel in position.

The smooth, convex, outer surface of the bagel presents an additional problem when attempting to cut the bagel into thirds or multiple slices on planes perpendicular to the axis of the hole. Most cutting blades directed at a surface at an angle tend to slide along that surface rather than ‘bite’ into it for the cut. Consequently, food preparers do not often try to make bagel sandwiches or other multilayered bagel preparations using conventional cutting methods.

A bagel is most safely cut by laying it on a flat surface, placing the palm of one hand on the top surface of the bagel, and engaging the outer circular edge of the bagel with a serrated bread knife. The knife is moved parallel to the plane of the support surface while the person keeps the fingers of the hand on the bagel and out of the cutting plane of the knife.

Many people are injured while cutting bagels. The source of the injuries is often improper equipment or improper procedures. For example, many people will use an ordinary, non-serrated knife. Such knives more easily slip on the smooth outer convex surface of the bagel and cut the hand that holds the bagel. Other injuries occur when the knife slices through the bagel into the hand holding the bagel, or when the bagel is cut while standing it on its convex edge.

The prior art has presented several devices which attempt to solve these problems. U.S. Pat. No. 2,396,443 of Singer discloses a multiple slicing device in which a multiplicity of straight and parallel knives are rigidly held in place. There is no shield protecting a user from injuring himself with these knifes, and the Singer device is relatively unsafe to use.

U.S. Pat. No. 2,453,220 of Gustafson discloses a slicing knife assembly comprised of a body portion 10 and a blade 24. Although one side of the Gustafson knife assembly is shielded, the other side of the blade 24, and its bottom surface, are unshielded.

U.S. Pat. No. 3,981,078 of Alberti discloses an electric knife with two mutually reciprocating cutting blades. As with the Singer and Gustafson devices, the user of the Alberti device has ample opportunity to cut himself as well as a bagel, the cutting blades of Alberti also not being shielded.

U.S. Pat. No. 5,903,983 of Gibson provides a hand-held bagel slicer whose blade 16 is shielded by legs 22 and 24 and either side of such blade. However, the tip 44 of the blade 16 is not shielded, and the tip of such blade 16 is not rigidly fixed in place on both of its ends. Thus, such blade is free to slide along the surface of the bagel and/or deflect during the cutting process.

It is an object of this invention to provide a blade assembly adapted to cut bagels that is safer to use and more effective than prior art blade assemblies.

### SUMMARY OF THE INVENTION

In accordance with this invention, there is provided a blade assembly that contains a first blade and a shield. The shield is comprised of a first sidewall and a second sidewall, wherein the first sidewall has a first top surface and a first bottom surface, and the second sidewall has a second top surface and a second bottom surface. The first blade is comprised of a first proximal end and a first distal end, a first means for bonding the proximal end to the shield, and a second means for bonding the distal end to the shield. The first blade does not extend above the first top surface or the second top surface, and the first blade does not extend below the first bottom surface or the second bottom surface. Each of the ends of the first blade is disposed within and attached to the shield.

### BRIEF DESCRIPTION OF THE DRAWINGS

FIG. 1A shows a bagel with markings indicating where it will be cut by the blade assembly of this invention;

FIG. 1B shows the bagel of FIG. 1A after it has been cut by such blade assembly;

FIG. 2A shows a side view of one preferred knife assembly;

FIG. 2B is a top view of a preferred knife assembly;

FIG. 2C is a top view of another preferred knife assembly;

FIG. 3A is a side view of a motorized knife assembly;

FIG. 3B is a top view of the knife assembly depicted in FIG. 3A;

FIG. 3C is a side view of a motorized knife assembly with tip spacers;

FIG. 3D is a top view of the knife assembly of FIG. 3C;

FIG. 3E is a top view of a motorized knife assembly;

FIG. 3F is a top view of a motorized knife assembly depicting the blades in paired reciprocating positions at the limits of their movement;

FIG. 4A shows a top view of the blade assembly of FIG. 3A during a cut through a bagel;

FIG. 4B is a close-up of the cut depicted in FIG. 4A;

FIG. 5A depicts the blade assembly of FIG. 3C, a bagel holder, and a bagel during a cut;

FIG. 5B shows an end view of the bagel holder for use with the knife assembly of FIG. 3C, with a bagel in position for cutting;

FIG. 6A shows the blade assembly of FIG. 3B, a bagel holder, and a bagel during a cut;

FIG. 6B shows an end view of the bagel holder for use with the knife assembly of FIG. 3B, with a bagel in position for cutting;

FIG. 7 shows a bagel holder with removable bagel holding parts;

FIG. 8A shows the blade assembly of FIG. 2C with blade spacers;

FIG. 8B shows the blade assembly of FIG. 2B with blade spacers;

FIGS. 9A through 9H show stages in the conversion of the blade spacing of the knife assembly of Figure to the blade spacing of the knife assembly in FIG. 2B;

FIG. 10 shows a side view of a knife assembly with two guards;

FIG. 11 is a top view of the knife assembly of FIG. 10;

FIG. 12 is another top view of the knife assembly of FIG. 10, showing certain internal detail;

FIG. 13 is a partial exploded view of knife assembly with three blades;

FIG. 14 is a schematic representation of a knife assembly with two guards;

FIG. 15 is another schematic representation of a knife assembly with two guards;

FIG. 16 is a side view of one preferred blade;

FIG. 17 is a top view of a knife assembly with a single guard;

FIG. 18 is another side view of a knife assembly with a single guard;

FIG. 19 is a schematic top view of a knife assembly with a single guard;

FIG. 20 is an exploded schematic view of a knife assembly with a single guard;

FIG. 21 is another schematic view of a knife assembly with a single guard;

FIG. 22 is a side view of two blades;

FIG. 23 is a schematic view of a blade assembly comprised of the blades of FIG. 22;

FIG. 24 is a top schematic view of an adjustable blade assembly;

FIG. 25 is a schematic side view of one preferred blade assembly;

FIG. 26 is a schematic end view of the blade assembly of FIG. 25;

FIG. 27 is a top perspective view of a preferred blade assembly that comprises only one blade;

FIG. 28 is a bottom perspective view of the blade assembly of FIG. 27;

FIG. 29 is another, enlarged top perspective view of the blade assembly of FIG. 27;

FIG. 30 is a side view of the blade assembly of FIG. 27;

FIG. 32 is a front view of the blade depicted in FIG. 31;

FIG. 33 is a schematic representation of a knife assembly being lowered into place into one of the guard of assemblies of the invention;

FIG. 34 is a side view of the assembly of FIG. 33 when the knife assembly has been lowered into place into the guard assembly and the guard assembly has been closed and locked;

FIG. 35 is a bottom view of the assembly of FIG. 33 when the knife assembly has been lowered into place into the guard assembly and the guard assembly has been closed and locked;

FIG. 36 is an end view of the assembly of FIG. 33 with the knife assembly disposed within the open guard assembly;

FIG. 37 is an end view of the assembly of FIG. 33 when the knife assembly has been lowered into place into the guard assembly and the guard assembly has been closed and locked;

FIG. 38 is a partial side view of one preferred blade used in the blade assembly of the invention;

FIG. 39 is a side view of two halves of a spacer used in one preferred blade assembly;

FIG. 40 is a schematic view of one preferred injection molding machine;

FIG. 41 is a schematic view of one preferred die assembly;

FIG. 42 is a schematic view of one preferred polymer feeding and conveying device;

FIG. 43 is a perspective view of one preferred injection molded part;

FIG. 44 is a flow diagram of a preferred process for making a preferred blade assembly;

FIG. 45 is a side view of one preferred blade used in the preferred blade assembly;

FIG. 46 is a top view of one preferred blade assembly;

FIG. 47 is a schematic side view of the blade assembly of FIG. 46;

FIG. 48 is a top view of another preferred blade assembly; and

FIG. 49 is a schematic side view of the blade assembly of FIG. 48.

### DESCRIPTION OF THE PREFERRED EMBODIMENTS

In the remainder of this specification, applicants will describe several preferred embodiments of the blade assemblies of their invention which, preferably, are hand-held kitchen utensils containing either a single or multiple knife blades utilized for the safe cutting of bagels or other bread (food) products. In this embodiment, the blade assembly is comprised of a plastic frame with an integral, lightweight handle and one or more stainless steel serrated blades attached to the plastic frame at both ends of such blade(s) so that the blade(s) is rigidly held in place. In this embodiment, it is preferred that the blades be positioned above the bottom edge of the frame to ensure the cutting edge of the blades do not contact the user's palm or fingers. In one aspect of this embodiment, the blade(s) is preferably sealed at each end and bonded to the plastic frame.

In one embodiment, the frame used in the blade assembly is comprised of or consists essentially of two elements; one being an ergonomically designed handle, the other being a blade embedded within a guard area. In this embodiment, the handle preferably uses a hollowed out area with an integral beam for structural support. There preferably are two elongated holes at each end of the beam providing an area for hanging the product on a hook.

In one embodiment, the blades are fixed at both ends but also are parallel to each other and parallel to the frame walls.

Applicants also disclose a novel manufacturing process that accommodates the different shrink rates between the plastic frame and the stainless steel blades. In this process, a sleeve is preferably utilized during the manufacturing process to accommodate shrinking of the plastic. The sleeve is a separate part that is slipped over one end of a blade prior to the time the blade is inserted into a steel mold. Thereafter, molten injection molded plastic encompasses the blade and the sleeve and forms the blade assembly upon cooling. The sleeve provides a cavity within the plastic frame that allows the blades to slide a small distance as the frame plastic shrinks in length during the curing process.

In one embodiment, utilizing multiple blades, the concept of minimum blade overlap is utilized to ensure proper cutting of the food. Such blade overlap can best be realized by viewing the product from the side and registering the blades within the frame such that the top of one blade coincides with the bottom of another blade at one fixed point. Beyond that point in both directions within the frame the blades increase in overlap with each other. In another embodiment, the blades increase in overlap with each other in only one direction.

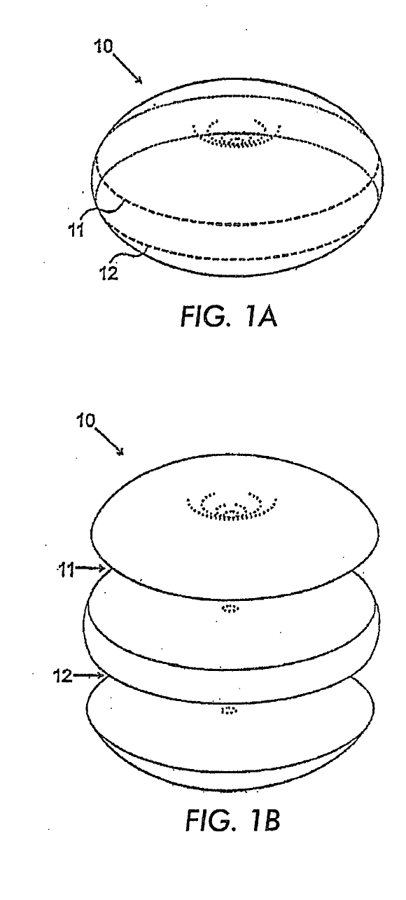

The aforementioned embodiments, and others, will be described in the remainder of this specification. Thus, and referring to FIG. 1A, a bagel 10 is depicted.

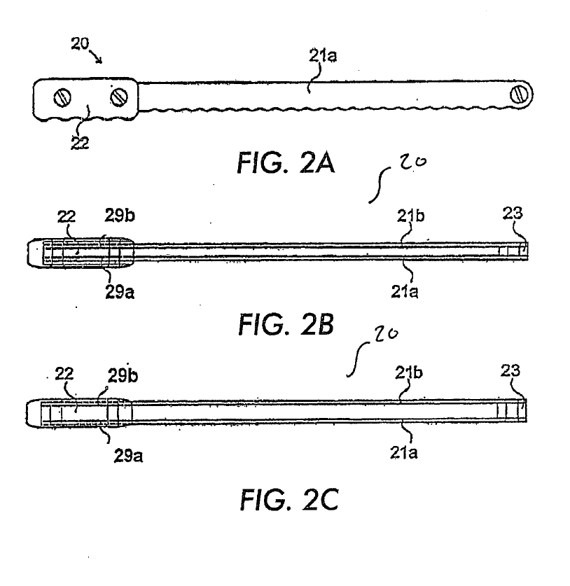

In one embodiment, the blade assembly of this invention (not shown in FIG. 1A) comprises two or more parallel cutting blades (not shown) for cutting a bagel 10 or other food item with two or more parallel cuts 11, 12. One such blade assembly is assembly 20, depicted in FIGS. 2A, 2B, and 2C.

In assembly 20, the blades 21a, 21b are anchored by their tangs 29a, 29b in a handle 22; such tangs hold and separate the blades 21a, 21b by a predetermined distance. Thus, e.g., referring to FIG. 2A, the blades 21a, 21b are anchored by their tangs 29a, 29b at a fixed distance from each other.

Referring to FIGS. 2B and 2C, and to the preferred embodiment depicted therein, the blades 21a, 21b are also anchored by their tips in a spacer 23 which holds the blades apart at a predetermined distance at the tips. Differently sized spacers 23 provide different spacings between such blades. In one aspect of the embodiment depicted in such Figures, removable spacing elements are incorporated into the handle and the spacer to permit changing the spacing between the blades. Said removable spacing elements are placed either between the blades or outside them depending on the space desired between the blades.

In the embodiment depicted in FIGS. 2B and 2C, two blades (21a and 21b) are depicted. It will be apparent to those skilled in the art that three or more such blades may be used, or only one such blade may be used.

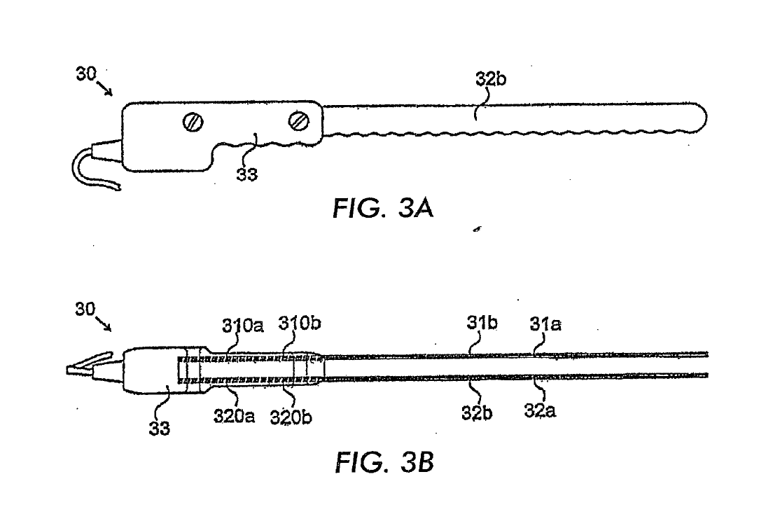

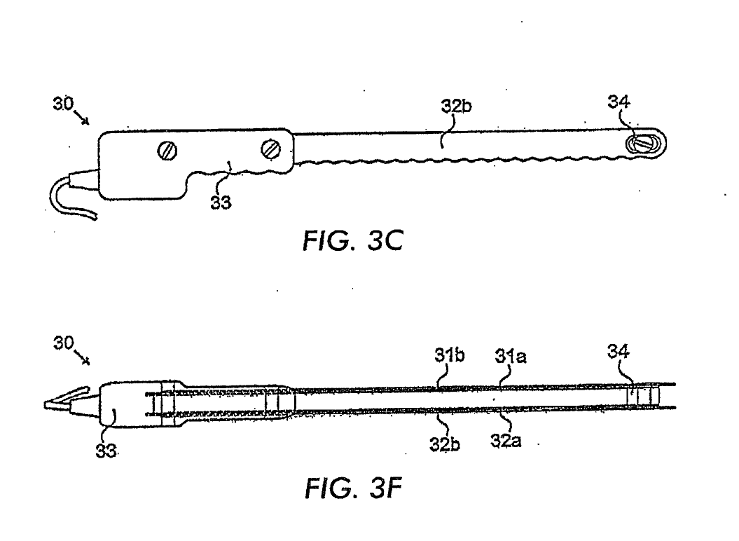

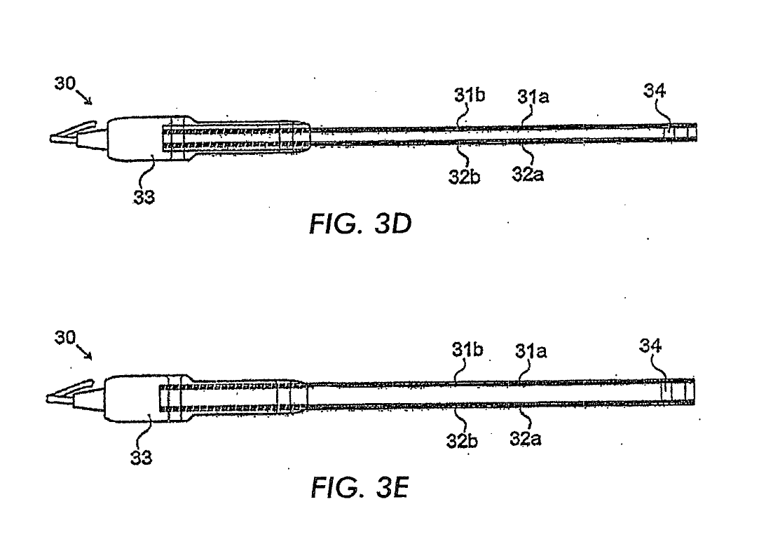

FIGS. 3A and 3B show a powered blade assembly 30 that is comprised of double-reciprocating blades 31a, 31b and 32a, and 32b driven by a motor in the handle 33. In one aspect of this embodiment, blades 31a, 31b and 32a, 32b are preferably anchored by their tangs 310a, 310b, and 320a, 320b at a fixed distance from each other. Optionally, and (as is depicted in FIG. 3C) blades 31a, 31b and 32a, 32b are also anchored by their tips in a spacer 34 which holds the blades apart at a predetermined distance at the tips. As in the manual embodiments, different powered double-reciprocating blade embodiments of the invention provide different spacings between blades 31a, 31b and blades 32a, 32b (as shown in FIGS. 3D and 3E). Furthermore, removable spacing elements may be incorporated into the handle 33 and the spacer 34 to permit changing the spacing between the blades. Said removable spacing elements are preferably placed either between the blades or outside them depending on the space desired between the blades.

FIG. 3F also depicts assembly 30, showing two double blades of the powered embodiment at the ends of their opposing reciprocating strokes. The double reciprocating blades 31a, 31b and 32a, 32b are paired as blade 31a with 32a and blade 31b with 32b so as to allow the spacer 34 anchoring the tips to keep all four blades in alignment for cutting.

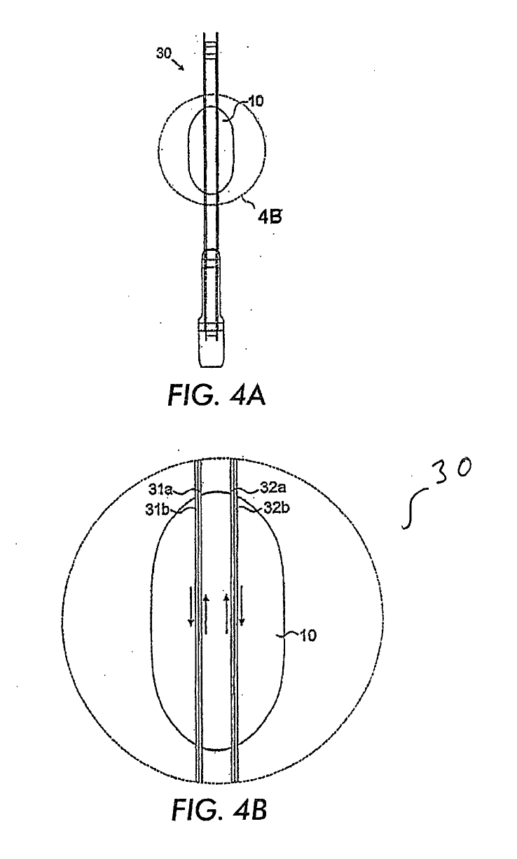

FIGS. 4A and 4B depict the operation of assembly 30 and, in particular, the operation of powered blades 31a, 31b and 32a, 32b. As will be apparent, via the use of such double-reciprocating blades 31a, 31b and 32a, 32b, force is applied in opposite directions simultaneously to the bagel 10 (not shown), stabilizing the bagel physically during the cutting process.

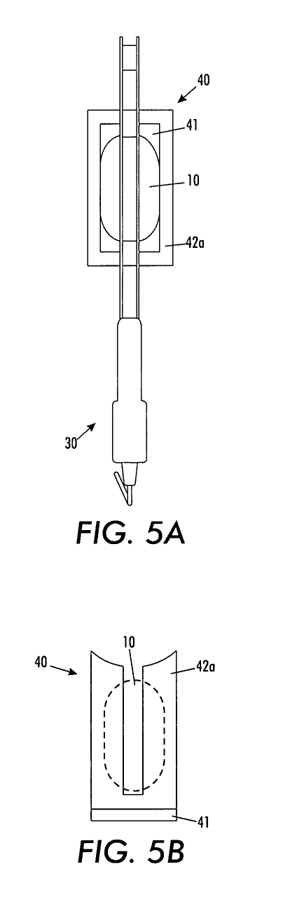

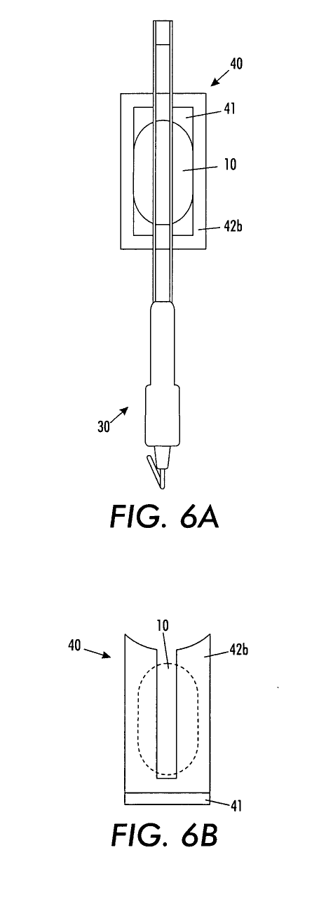

FIGS. 5A and 5B depict a holder 40 adapted to keep a bagel 10 stationary during either manual or powered cutting with the knife 20 or the knife 30. One may use one set of positioning parts 42a for more-widely-spaced cuts (see FIGS. 5A and 5B), and another set of positioning parts 42b for more-narrowly-spaced cuts (see FIGS. 6A and 6B). Although a center element between the knife blades or blade pairs may be incorporated in the holder, the holder 40 does not require a center element between the knife blades. The holder's two sides confine the knife blades precisely, and the knife blades are firmly anchored at both ends of the knife (see FIGS. 2C and 2D, and 3C through 3F).

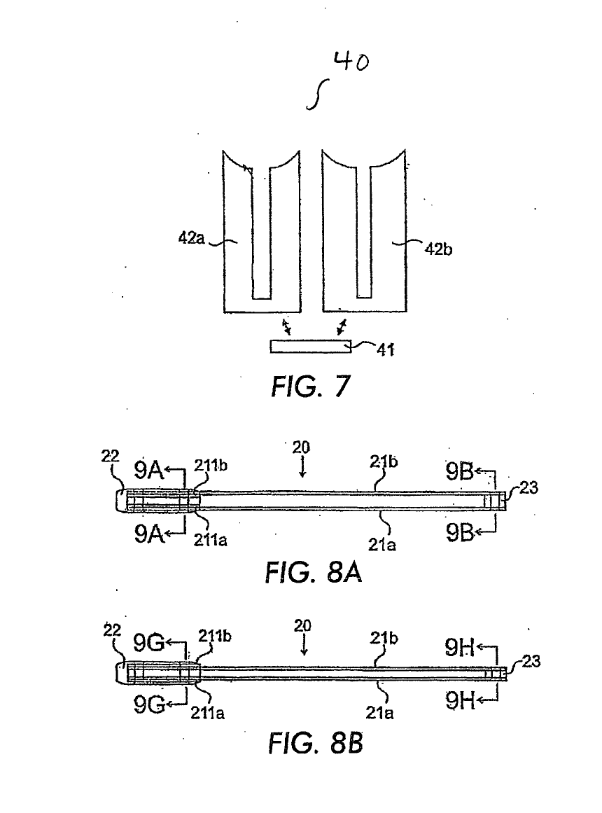

As is illustrated in FIG. 7, the holder 40 preferably comprises a base part 41 and one or more positioning parts 42a, 42b. The holder's base part 41 is preferably the same for all embodiments. The holder's positioning parts 42a, 42b are sized and spaced so as to guide the blades accurately. Either set 42a or set 42b of the positioning parts may be mounted on the holder's base part 41.

As will be apparent, the assemblies thus depicted allow a user to change the space between the knife blades as needed for different thicknesses of cut. This is illustrated, e.g., in FIGS. 8A and 8B.

FIG. 8A shows knife 20 of FIG. 2C with a wider spacing between blades 21a and 21b. FIG. 8B shows such knife 20 of FIG. 2B with a narrower spacing between blades 21a and 21b.

One may convert the knife from the embodiment depicted in FIG. 8A to that depicted in FIG. 8B by removing and repositioning the spacing elements between the blades.

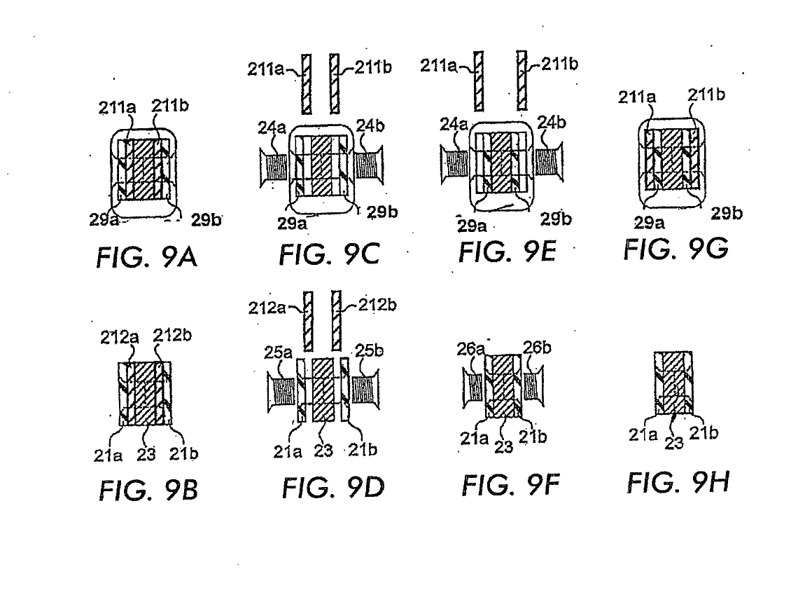

FIGS. 9A and 9B illustrate cross-sections of the knife handle 22 and the blade spacer 23 respectively for the knife configuration of FIG. 8A. In the embodiment illustrated in FIG. 9A, blade tangs 29a, 29b are positioned outside blade spacers 211a, 211b. The user removes screws 24a, 24b (as shown in FIG. 9C) and then removes tang spacers 211a, 211b.

In FIG. 9B, blades 21a, 21b are positioned outside spacers 212a, 212b. The user removes screws 25a, 25b (as shown in FIG. 9D), and then removes spacers 212a, 212b. In the next step of conversion, the user repositions blade tangs 29a, 29b closer together (as shown in FIG. 9E) and reinserts tang spacers 211a, 211b as shown, outside blade tangs 29a, 29b. The user then repositions blades 21a, 21b closer together (as shown in FIG. 9F), removing tip spacers 212a, 212b altogether and replacing screws 25a, 25b with shorter screws 26a, 26b. On refastening all screws (as shown in FIGS. 9G and 9H), the blades are now positioned closer together (as shown in FIG. 8B).

In one embodiment, there is provided a double sided guard knife. In one aspect of this embodiment, there is provided a blade assembly comprised of a blade and a frame. The frame is comprised of a front wall, a back wall, a first sidewall, and a second sidewall. The blade is disposed between the first sidewall and the second sidewall and is surrounded by the frame. A first end of the blade is embedded within the front wall of the frame, and a second end of the blade is embedded within the back wall of the frame.

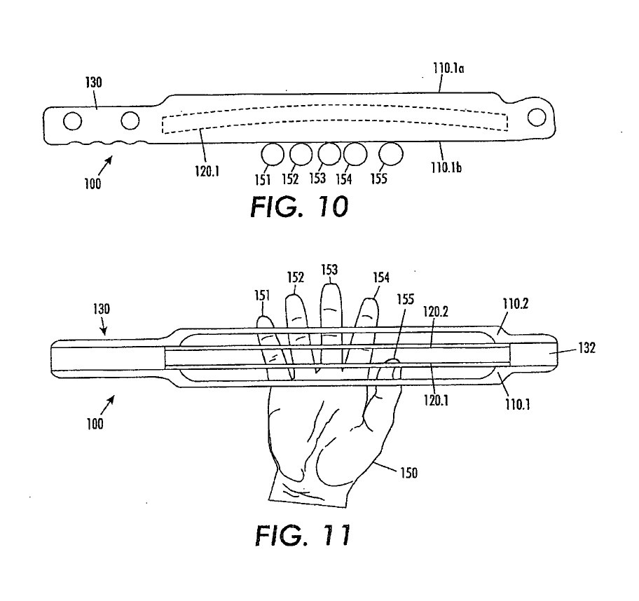

A dual-sided guard knife 100 is shown in FIGS. 10, 11, and 12. Referring to such Figures, it will be seen that longitudinal guards 110.1 and 110.2 oppose the outer facing sides of the blades 120.1, 120.2. The guards are spaced to permit bagels, rolls or other food items to pass between the guards 110.1 and 110.2 in order to be cut by the blades 120.1 and 120.2.

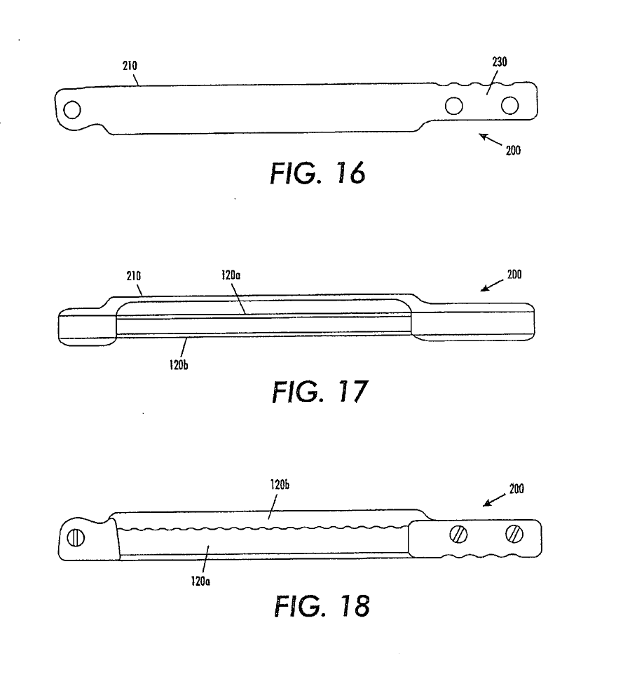

FIGS. 16-21, show the single-sided guard knife 200. All embodiments having longitudinal guards 110, 210 may have the same spacer structures and function as described elsewhere in this specification. The assemblies so disclosed may be fabricated either in integral form (for permanent use in a single configuration) or in modular form (for disassembly, cleaning, part replacement, or reconfiguration of spacings and blades).

Referring to FIGS. 10 and 11, it will be seen that knife assembly 100 has a handle 130, a pair of parallel blades 120.1, 120.2, and a corresponding pair of guards 110.1, 110.2 disposed outside the respective blades. In one aspect of this embodiment, the ends of blades 120.1 and 120.2 are attached to either such guards 110.1/110.2 and/or to such handle 130.

The guard 110.1 has an upper edge 110.1a and a lower edge 110.1b. As seen in FIG. 10, the blades 120.1, 120.2 in phantom are laterally and vertically isolated. In other words, even if a person's hand 150 or fingers 151-155 were beneath the blades 120.1, 120.2, the lower edges 110.1b, 110.2b (not shown) of the guards would protect the hand 150 and fingers 151-155 from the blades 120.1, 120.2. The guards 110.1, 110.2 completely cover the outer side of each blade 120.1, 120.2 and extend below the cutting edges of the blades to protect the hand 150 or fingers 151-155 of a person who mistakenly places his hand or fingers beneath the knife 100 while cutting. In other words, each such blade is completely surrounded by one or more of such guards.

In one embodiment, the guards 110.1, 110.2, the handle 130, and a tip spacer 132 are molded around the blades 120.1, 120.2 to form the knife 100. The blades 120.1 and 120.2 are thus laterally reinforced by the handle, tip spacer and guards.

The structure of the knife 100 is preferably relatively rigid. The blades 120.1, 120.2 are supported laterally and vertically at each of their ends.

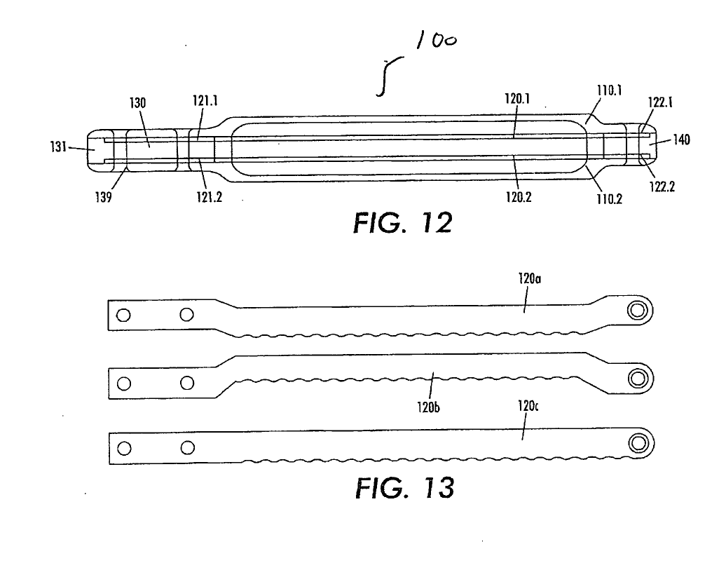

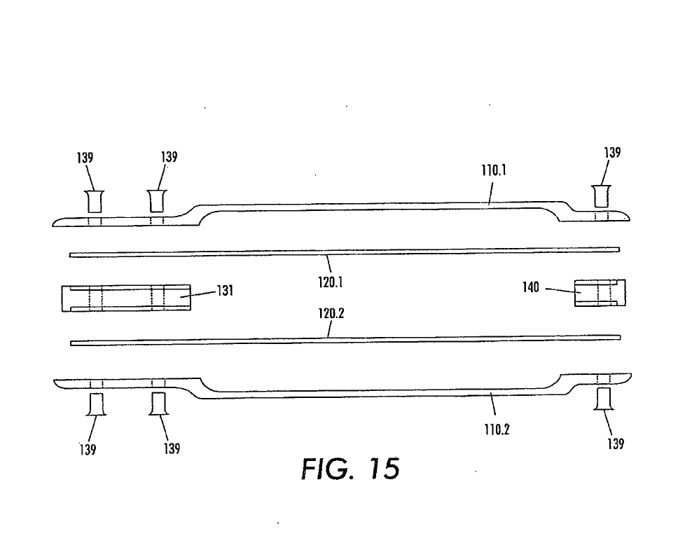

The knife 100 may also be constructed from individual elements that are assembled together with suitable fasteners. Reference may be had, e.g., to FIGS. 12 and 15 that show, respectively, assembled and exploded views of the structure of one dual-sided guard knife. A handle spacer 131 and the tip spacer 140 are preferably in the center of the structure. Blades 120.1, 120.2 are on opposites sides of the handle, and tip spacers and guards 110.1, 110.2 are outside the blades. Rivets 139 extend into openings of the guards, blades, handle and tip spacer to assemble and hold the parts together. The tangs 121.1, 121.2 of the blades 120.1, 120.2 are anchored in the knife handle element 131 by one or more rivets 139. The tips 122.1, 122.2 of the blades are likewise anchored in a tip spacer 140 by rivet 139. The guards 110.1, 110.2 are anchored both at the handle 130 and the tip spacer 140 by the same rivets.

In one embodiment, the blades used in the blade assembly may be offset vertically with respect to each other. In other words, the blades, though preferably parallel, may have their cutting edges disposed at different depths with respect to each other. This allows the cutting edge of one blade to lead the cutting edge of the other blade. The offset arrangement of the leading cutting edges reduces friction experienced by two blades that are both parallel and aligned. Where the blades are aligned with their lower edges in the same plane, the center cut slice between the blades may become compressed. If so, the compressed slice presses against both the blade surfaces and increases frictional force that inhibits cutting. By jogging or offsetting the relative depths of the cutting edges of the blades with respect to each other, the leading edge of the lower blade acts, at least initially, like a single blade. There is no compressive force exerted on the inside surface of the leading edge of the lower blade because the other blade is vertically offset from it. This “staggered assembly” facilitates the cutting of items such as, e.g., bagels.

FIG. 13 illustrates one means of producing an assembly with offset (“staggered”) blades. Referring to FIG. 13, it will be seen that blades 120a, 120b, and 120c may be used. The top blade 120a in FIG. 13 places the blade's cutting edge closer to the lower edge of the guard. The middle blade 120b in FIG. 13 places the blade's cutting edge farther from the lower edge of the guard. The bottom blade 120c in FIG. 13 places the blade's cutting edge at a middle distance from the lower edge of the guard. The blade assembly may thus be fabricated with two or three blades to provide staggered leading edges.

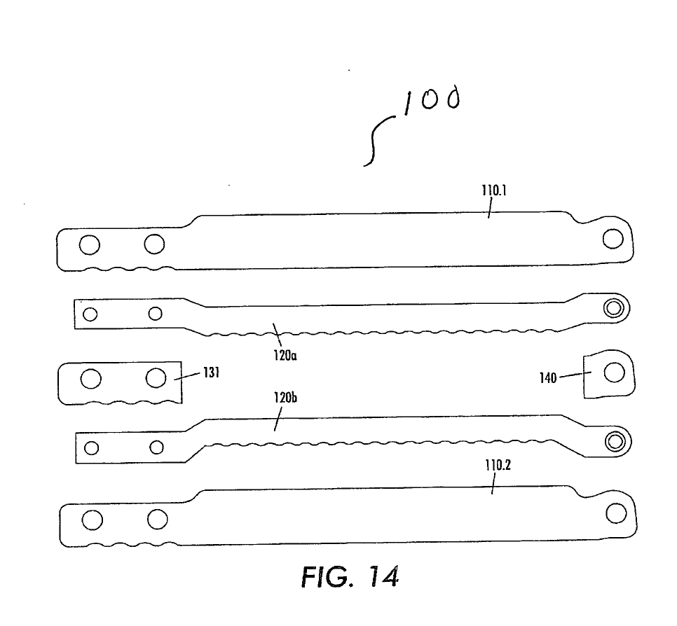

FIGS. 14 and 15 illustrate the major components of the knife 100 with a dual guard assembly, in a side view and top assembly view. One guard 110.1 is at top, then a blade 120a, then a handle spacer 131 and a tip spacer 140, another blade 120b, and the second guard 110.2. The handle 130 comprises handle spacer 131 and the handle ends of the guard 110.

Referring to FIGS. 16, 17, and 18, it will be seen that knife assembly 200 may be comprised of one longitudinal guard 210 on only one side of the blades 120a and 120b. The guard 210 is spaced from the proximate blade to permit the cutting of two slices of bread from the side of a loaf of bread or to cut a bagel into three slices. The guard 210 blocks hand access to the cutting edges of the blades 120a, 120b.

FIG. 16 shows an inverted closed-side view of the knife 200 with a single guard 210, in an embodiment for right-handed use in carving from the side or end of a large food item such as a roast or a loaf of bread. The view is inverted top-to-bottom to make it consistent with the two figures that follow. The closed side of this embodiment is similar to the closed side of the knife embodiment 100.

FIG. 17 shows a top view of the knife 200 with a single guard 210, in an embodiment for right-handed use. Note that the guard 210 of this embodiment may be made thicker than that of the full guard embodiment.

FIG. 18 shows the open-side view of the knife 200 with a single guard 210, in an embodiment for right-handed use. Note the relative positions of the two cutting blades 120a, 120b that have their lower, leading edges vertically spaced or offset from each other. The blade 120a closer to the viewer is positioned lower than the blade 120b. This positioning may be reversed or changed as required. This positioning may be done in the same way for the dual-sided guard knife 100.

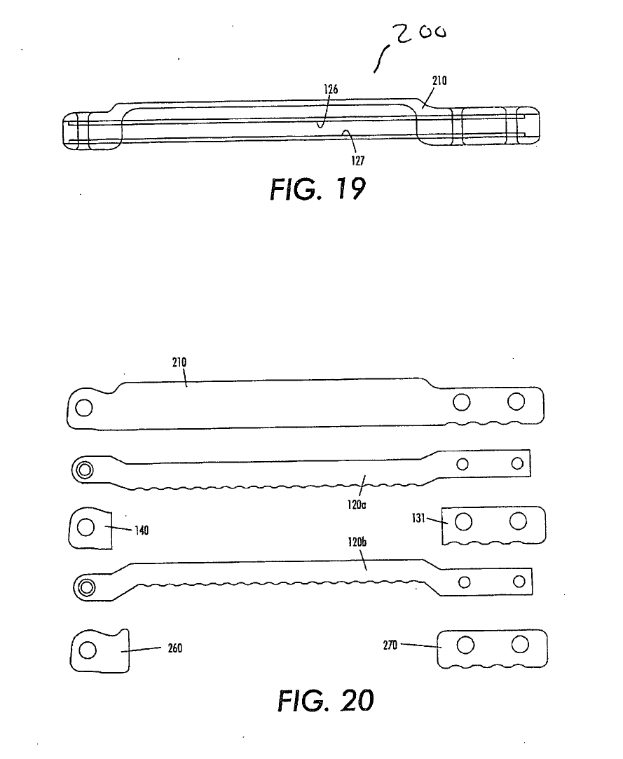

FIG. 19 shows some internal detail of the knife 200 of FIGS. 16-18. FIG. 20 FIG. 20 shows the major components of the knife 200 of FIGS. 161-9, in side views.

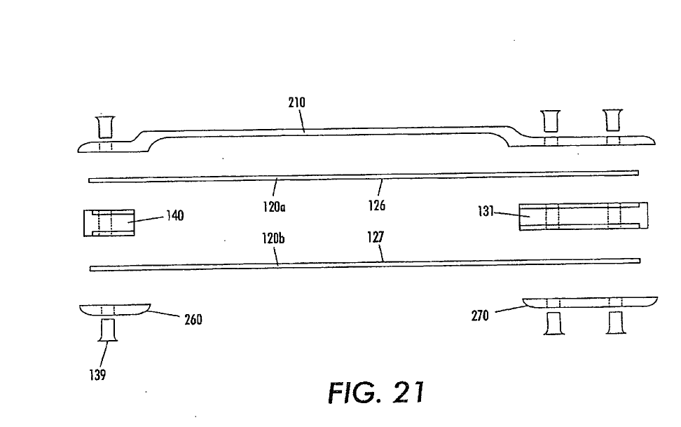

FIG. 21 shows an expanded assembly view of the element 200. A guard 210 is at top, then a blade 120a, then a handle spacer 131 and a tip spacer 140, another blade 120b, and a tip facing 260 and a handle facing 270. The handle 230 comprises handle spacer 131, the handle end of the guard 210, and the handle facing 270. The assembly may be done once when the knife is fabricated in an integrated embodiment, or may be done by the user at any time for the modular embodiments. In one embodiment, rivets 139 extend through openings in the parts to secure the parts to the handle and tip spacers.

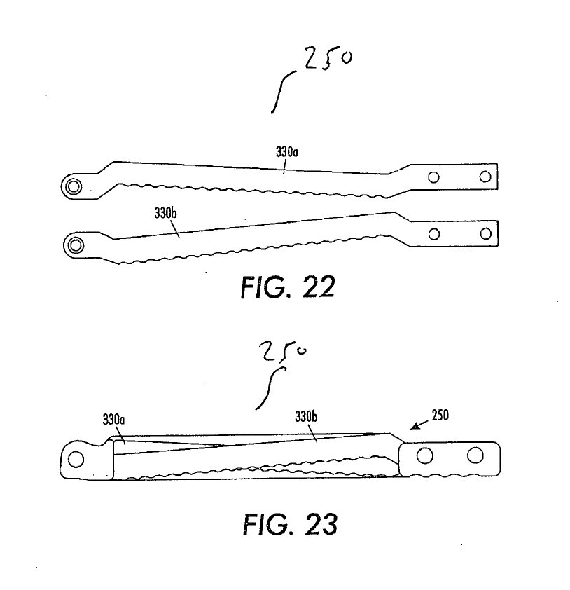

The knife assembly 250 may be fabricated so as to position the blades with their cutting edges at opposing longitudinal angles (see FIGS. 22 and 23). A cut made with the knife 250 will start near one end of the blade, either the handle end or the tip end. One blade will engage the food item first and the cutting action will move the food item toward and past the center of the blade's length. A return cut will then engage the food item with the other blade slanted to move the food item in the opposite direction, thereby tending to keep the food item centered along the length of both blades.

FIG. 22 shows a pair of centering blades 330a, 330b to be used in assembly 250, and FIG. 23 shows the knife assembly 250 with a half guard having two centering blades 330a, 330b mounted for use. This embodiment also reduces the amount of bread surface that is on the inner faces of the knives. Reducing the area of surface contact on the opposing surfaces 126, 127 (See FIG. 19) reduces the frictional forces generated by the central, sliced bread on the blades and makes it easier to simultaneously cut three slices.

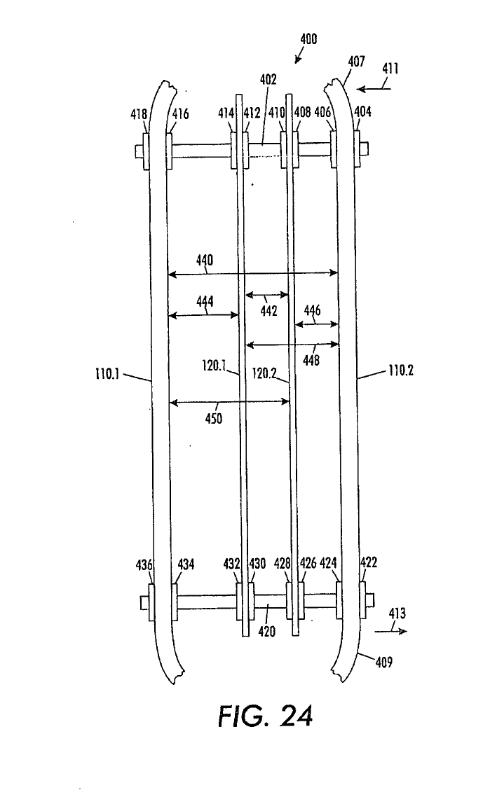

FIG. 24 is a schematic view of a knife assembly 400 that is comprised of a pair of guards 110.1 and 110.2, a pair of blades 120.1 and 120.2, means 402, 404, 406, 408, 410 412,414,416, and 418 for varying the distance 423 between blades 120.1 and 120.2, means 412, 414, 416, 418, 420, 422, 424, 426, 428, 430, 432, 434, 436, 438, and 440 for varying the distance between the guards 110.1 and 110.2.

Referring to FIG. 24, and to the preferred embodiment depicted therein, it will be seen that the guards 110.1 and 110.2, and also the blades 120.1 and 120.2, are mounted on a pair of threaded shafts 402 and 420. Disposed on said threaded shaft 402 is a multiplicity of threaded nuts 404, 406, 408, 410, 412, 414, 416, and 418. Disposed on said threaded shaft 420 is a multiplicity of threaded nuts 422, 424, 426, 428, 430, 432, 434, and 436. As will be apparent to those skilled in the art, the position of each of said threaded nuts on the shaft on which it is disposed can be varied by rotating the nut in either a clockwise or counterclockwise direction. Thus, e.g., the position of the guards and/or the blades disposed between any set of nuts may also be varied.

By way of illustration, guard 110.2 is disposed between nuts 404 and 406 at its top 407, and it is disposed between nuts 422 and 424 and its bottom 409. As will be apparent, the when nuts 404 and 406 are moved in a counterclockwise direction, the top 407 of guard 110.2 is moved in direction 411. Conversely, when the 422 and 424 are moved in a clockwise direction, the bottom 409 of guard 110.2 is moved in the direction 413.

The distance 440 may be varied by adjusting the nuts disposed around guards 110.1 and 110.2. Similarly, the distance 442 between blades 120.1 and 120.2 may also be varied by adjusting the nuts disposed around such blades. Similarly, the distance 444 (between blade 120.1 and guard 110.1), the distance 446 (between blade 120.2 and guard 110.2), the distance 448 (between blade 120.1 and guard 110.2), and the distance 450 (between blade 120.2 and guard 110.1) may also be varied.

Referring again to FIG. 24, each of guards 110.1 and 110.2, and each of blades 120.1 and 120.2 are preferably substantially parallel to each other. Furthermore, in the embodiment depicted, each of threaded bolts 402 and 422 are substantially coplanar

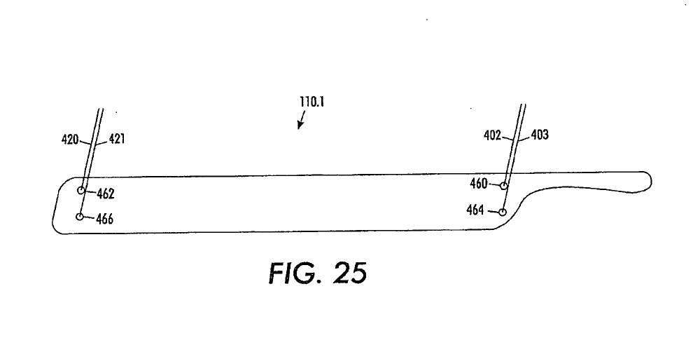

In another embodiment, schematically illustrated in FIG. 25, a multiplicity of threaded bolts that are not coplanar are utilized. FIG. 25 is a side view of a guard 110.1 which is comprised of a multiplicity of orifices 460, 462, 464, and 466. Disposed within orifices 460 and 462 are threaded bolts 402 and 420. Disposed within orifices 464 and 466 are threaded bolts 403 and 421. As will be apparent, the representation in FIG. 25 is schematic, and does not correspond to the proper scale, angles, or dimensions. As will also be apparent, similar orifices 460/462, and 464/466 appear on the other guard used in the assembly guard 110.2.

Referring again to FIG. 25, from which detail has been omitted for the sake of clarity of illustration, it will apparent that one may mount knives 120.1 and 120.2 at different heights and/or at different spacings.

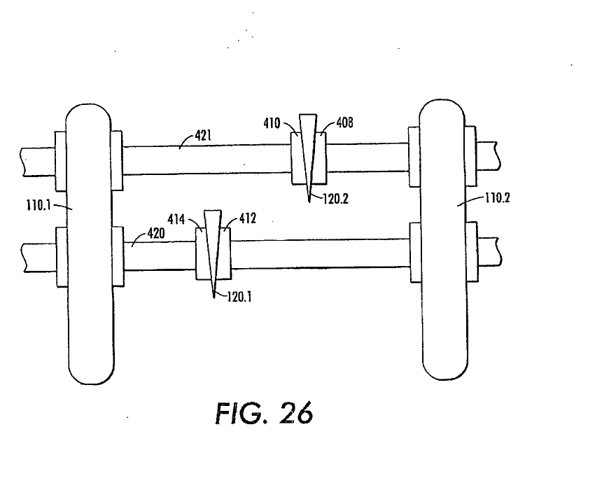

FIG. 26 illustrates another end view of the assembly of FIG. 25.

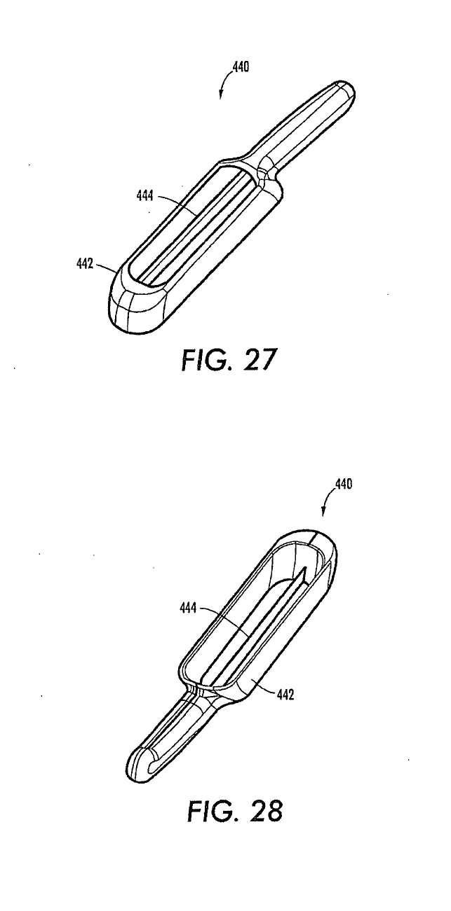

FIG. 27 is a top perspective view of another preferred blade assembly 440 that comprises only one blade. Referring to FIG. 27, and the preferred embodiment depicted therein, it will be seen that blade assembly 440 is comprised of a housing 442 and a blade 444 disposed therein. The blade 444 preferably has its two ends disposed within and bonded to the housing 444; and none of the surfaces of the blade 444 extend above the top surface or below the bottom surface of the housing 442.

In one preferred embodiment, the housing 442 is an integral assembly that is preferably made from injection molded plastic. In one aspect of this embodiment, the injection molded plastic is transparent injection molded plastic so that, while in use, one may see a bagel being cut by the blade 444.

In one embodiment, the blade assembly 440 is comprised of a blade and a frame, wherein: (a) said frame is comprised of a front wall, a back wall, a first sidewall, and a second sidewall; (b) said blade is disposed between said first sidewall and said second sidewall, and (c) said blade has a first end and a second end wherein said first end is embedded within said front wall, and said second end is embedded within said back wall. Although one blade is shown in assembly 440, it will be apparent that such assembly may contain two or more blades, each similarly attached to the frame.

It is preferred that the frame 442 (also referred to as “housing 442”) be comprised of at least about 50 weight percent of plastic material. As used herein, the term plastic refers to a polymeric material (usually organic) of large molecular weight that can be shaped by flow; and the term refers to the final product, with fillers, plasticizers, pigments, and stabilizers included. Reference may be had, e.g., to page 1443 of Sybil B. Parker's “McGraw-Hill Dictionary of Scientific and Technical Terms,” Fourth Edition (McGraw-Hill Book Company, New York, N.Y., 1989).

In one embodiment, the frame 442 is comprised of at least about 80 weight percent of plastic material. In another embodiment, the frame 442 is comprised of at least 90 weight percent of plastic material. In yet another embodiment, the frame 442 is comprised of at least about 95 weight percent of plastic material.

In one preferred embodiment, the plastic material is injection molded plastic material. These materials are well known and are described, e.g., in U.S. Pat. Nos. 3,924,881 (injection molded plastic pipe fitting), 4,255,825 (boots of injection molded plastic), 4,564,113 (injection molded plastic closure), 5,413,838 (injection molded plastic boss design), 5,526,954 (injection molded plastic bucket), 5,958,440 (injection molded plastic article), 6,759,140 (injection molded plastic part), and the like. The entire disclosure of each of these United States patents is hereby incorporated by reference into his specification.

In one preferred embodiment, the plastic has a mold shrinkage, as tested with a ⅛″ specimen, of from about 0.003 to 0.020 inches/inch. The mold shrinkage is determined with a 0.125″ specimen in accordance with A.S.T.M. Standard Test D955-00 (November, 2000), “Standard Test Method of Measuring Shrinkage from Mold Dimensions of Thermoplastics.” In one aspect of this embodiment, the mold shrinkage of the plastic is from about 0.007 to about 0.014 inches/inch.

In one preferred embodiment, the plastic has a notched Izod impact strength of from about 1.0 to about 1.5 foot-pounds per inch and, more preferably, from about 1.2 to about 1.3 foot-pounds per inch. The izod impact strength of the plastic is measured using A.S.T.M. Standard Test D256-06a (December, 2006, “Standard Test Method for Determining the Izod Pendulum Impact Resistance of Plastics.”

In one embodiment, the plastic has a water absorption (measured after 24 hours in accordance with ASTM D-570-98 [November, 2005], “Standard Test Method for Water Absorption of Plastics”) of less than about 5 percent and, more preferably, less than about 1 percent. In one embodiment, such water absorption is less than about 0.1 percent.

In one embodiment, the plastic has a Shore Hardness of from about 68 to about 73. The Shore hardness is determined in accordance with A.S.T.M. Standard Test Method D1415-06 (October, 2006, “Standard Test Method for Rubber Property—International Hardness).

It is preferred that the plastic be a thermoplastic polymer. As is known to those skilled in the art, a thermoplastic polymer is a high polymer that softens when exposed to heat and returns to its original condition when cooled to room temperature. The thermoplastic is preferably a synthetic thermoplastic material that is preferably selected from the group consisting of polyvinyl chloride, nylons, fluorocarbons, linear polyethylene, polyurethane prepolymer, polystyrene, polypropylene, and cellulosic and acrylic resins.

In one preferred embodiment, the plastic is polypropylene that, preferably, is filled with from about 10 to about 40 weight percent of inorganic filler. Regardless of the plastic material used, it is preferred that it be filled with such inorganic filler. Thus, by way of illustration, the plastic used may be “PROLIFIL RMC,” a calcium carbonate reinforced polypropylene that is available from The Plastics Group of America, 1112 River Street, Woonsocket, R.I.

One may use any of the mineral fillers conventionally used with plastics. Thus, by way of illustration and not limitation, one may use one or more of the fillers described in U.S. Pat. Nos. 3,969,314 (production of plastic-filler mixtures), 4,174,340 (plastic molding composition containing a filler), 4,356,230 (molded plastic product having a plastic substrate containing a filler), 4,456,710 (filler-containing plastic molding composition), 5,202,076 (method for producing multi-layer pipe conduit components of plastic material, inorganic filler material, and glass fibers), 5,756,211 (method of manufacturing high filler content plastics having a glitter appearance), 5,800,910 (plastic molded articles having a polymer matrix filled with inorganic particles), 5,804,116 (method for the manufacture of shaped bodies formed from plastics-filler mixtures having a high filler content), 6,469,086 (plastic molding compound, composite body, and filler for a plastic molding compound), 7,019,048 (plastic part comprising lustrous pigments and filler particles), and the like. The entire disclosure of each of these United States patents is hereby incorporated by reference into this specification.

In one preferred embodiment, the plastic material is also comprised of from about 0.1 to about 10 weight percent of pigment that, preferably, is an inorganic pigment. Commonly used inorganic pigments include titanium dioxide, zinc sulfide, iron oxides, chromates, cadmiums, chromium oxides, ultramarines, mixed metal oxides, and carbon black. Reference may be had, e.g., to U.S. Pat. Nos. 3,784,393 (pigmented plastics), 3,811,627 (apparatus for introducing controlled amounts of pigment into thermomechanically formed plastic), 4,127,555 (pigmentation of plastics moulding material), 4,230,501 (pigments dispersible in plastics), 5,350,792 (pigment-containing plastic molding composition), 5,700,318 (durable pigments for plastic), 5,837,761 (pigmented plastics compositions), and the like. The entire disclosure of each of these United States patents is hereby incorporated by reference into this specification.

In one preferred embodiment, the plastic material is comprised of an effective amount of an antimicrobial agent. One may make the housing 442 out of any of the antimicrobial agents known to impart such properties to plastic such as, e.g., the materials disclosed in U.S. Pat. No. 6,585,989, the entire disclosure of which is hereby incorporated by reference into this specification. As is disclosed in such patent, “The present invention relates to combinations of phenolic and inorganic compounds which exhibit excellent antimicrobial activity when incorporated into a substrate resin. . . . ”

Other means of making antimicrobial plastic articles are also known. Thus, and referring to claim 1 of U.S. Pat. No. 5,976,562, the entire disclosure of which is hereby incorporated by reference into this specification, this patent provides “1. A method for producing antimicrobial plastic bodies, comprising the steps of: a) providing a plastic blank for forming said plastic body; b) providing antimicrobial particles of at least one antimicrobially active metal or metal compound; c) coating the plastic blank with said antimicrobial particles by a chemical or physical method; d) processing the coated blank by at least one of comminuting and melting down; and e) forming the processed blank into a desired shape, which is said plastic body, wherein the antimicrobial particles of metal or metal compound are embedded in the plastic in the form of discrete particles.”

In one preferred embodiment, the plastic material is comprised of means for producing an algicide or a bactericide after being exposed to electromagnetic radiation by, e.g., a “photodynamic action” (i.e., upon irradiation with light they act as catalysts for the oxidation of various substrates with oxygen). Some of these “photodynamic catalysts” are discussed in column 1 of U.S. Pat. No. 4,530,924, the entire disclosure of which is hereby incorporated by reference into this specification. As is disclosed in column 6 of such patent, the phthalocyanine compounds of this patent develop antimicrobial activity upon being irradiated by visible and/or infrared light.

Such means may be a photocatalyst, as that term is defined in U.S. Pat. No. 5,541,096, the entire disclosure of which is hereby incorporated by reference into this specification. This patent discloses that algae, fungi, and bacteria may be killed when titanium oxy compounds (such as titanium oxides) are exposed to electromagnetic radiation.

By way of further illustration, one may use the photocatalytic hydrophilic coating compositions disclosed in U.S. Pat. No. 5,916,947, the entire disclosure of which is hereby incorporated by reference into this specification. This patent discloses that, when exposed to visible light, “aqueous aerated solutions containing zinc oxide pigment leads to the formation of hydrogen peroxide only when exposed to ultraviolet light of wavelengths greater than 400 nm . . . ” (see columns 1-2).

One may use the titanium oxide toxic agent precursor disclosed in U.S. Pat. No. 6,291,067, the entire disclosure of which is hereby incorporated by reference into this specification.

One may use one of the “oxygen molecule absorbing/desorbing” agents disclosed in U.S. Pat. No. 6,294,247, the entire disclosure of which is hereby incorporated by reference into this specification. As is disclosed in column 1 of this patent, “TiO₂, V₂O₅, ZnO, WO₃, etc. have heretofore been known as substances which, when irradiated by ultraviolet radiation, cause oxygen molecules to be adsorbed to or desorbed from an organic compound such as a smelly constituent for promoting decomposition (oxidation) of the organic compound. . . . ”

One may use a photocatalytic material that is activated by visible light such as, e.g., the material disclosed in U.S. Pat. No. 6,835,688, the entire disclosure of which is hereby incorporated by reference into this specification. As is disclosed in column 1 of this patent, “Conventionally known materials exhibiting a photocatalytic action include TiO2 (titanium dioxide), CdS (cadmium sulfide), WO3 (tungsten trioxide), and ZnO (zinc oxide), for example.”

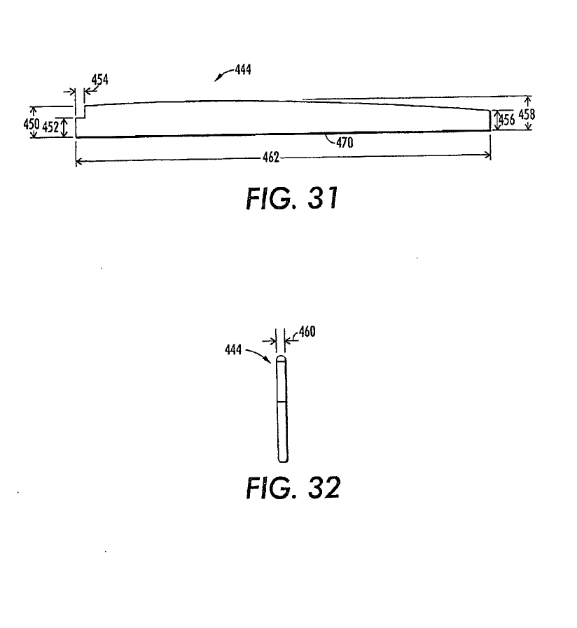

Referring again to FIG. 28, it will be seen that blade assembly 440 is comprised of a blade 444, one embodiment of which is depicted in FIGS. 31, 32 and 33. In one preferred embodiment, the dimensions 450, 452,454, 456, 458, and 460 are, respectively, 15.97 millimeters, 10 millimeters, 5 millimeters, 10.47 millimeters, 17.44 millimeters, and 1.5 millimeters. The blade 444 has a length 462 of 215 millimeters.

In one preferred embodiment, the blade 444 has a cutting edge with 3.8 serrations per inch and a bevel 10 millimeters from the cutting edge on one or both sides. The blade 444, in one embodiment, preferably is made from 1.5 millimeter stainless steel 304 or better. In one aspect of this embodiment, the stainless steel contains at least about 18 percent of chromium and at least about 8 weight percent of nickel. In another aspect of this embodiment, the blade is a 420 series stainless steel that contains 0.15 percent of carbon, 1 percent of manganese, and from about 12 to about 14 percent of chromium; and such blade has a hardness of from about 49 to about 53.

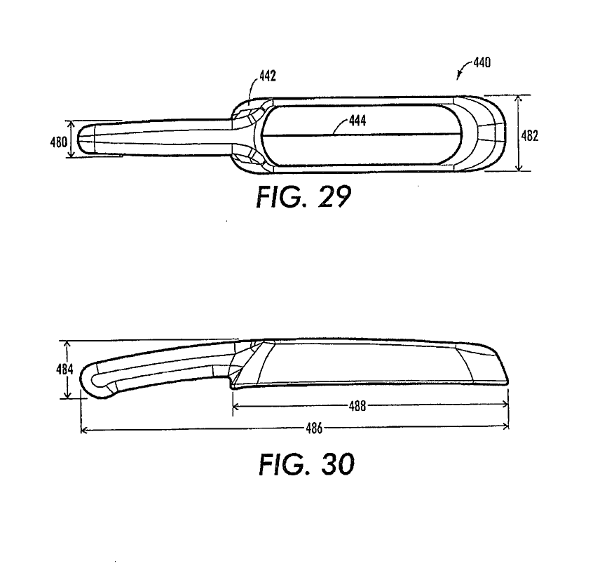

Referring again to FIGS. 28, 29, and 30, the dimensions 480, 482, 484, 486, and 488 are, respectively, 1.29 millimeters, 2.59 millimeters, 1.93 millimeters, 14.83 millimeters, 9.55 millimeters.

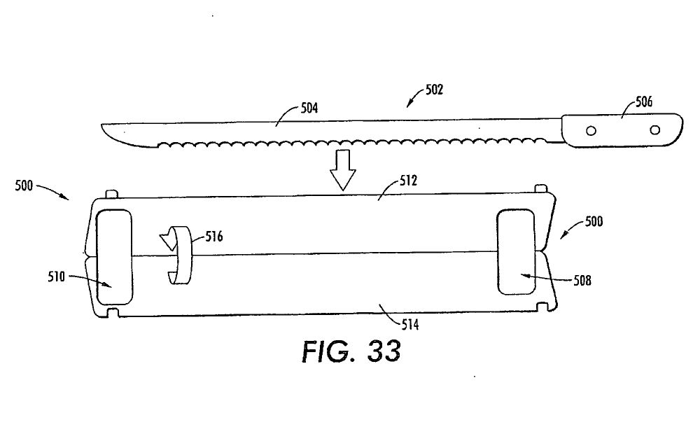

FIG. 33 is a schematic representation of a kitchen knife guard assembly 500 into which a kitchen knife 502 comprised of a blade 504 and a handle 506 is being lowered into assembly 500 to be supported by pads 508 and 510 when the sides 512/514 of such assembly are rotated in the direction of arrow 516 are releasably locked to each other. In one aspect of this embodiment, when the sides 512/514 are releasably locked together, the pads 508/510 form a pocket (not shown) in which blade 504 nests.

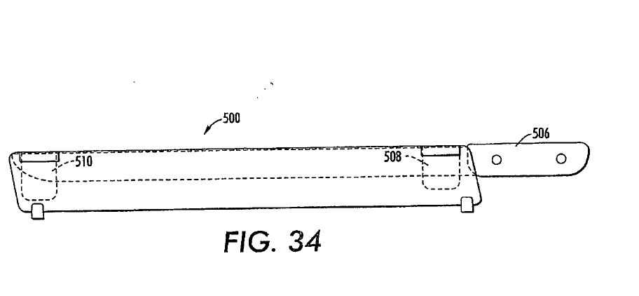

FIG. 34 is a side view of assembly 500 in its locked position with the blade 504 shown (in dotted line outline) nesting within pads 508/510 within the pocket (not shown in FIG. 34, but see FIG. 37)

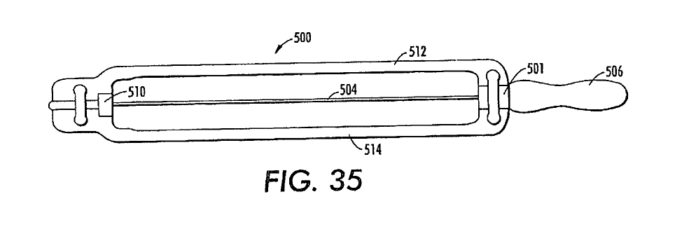

FIG. 35 is a bottom view of the assembly 500 in its locked position.

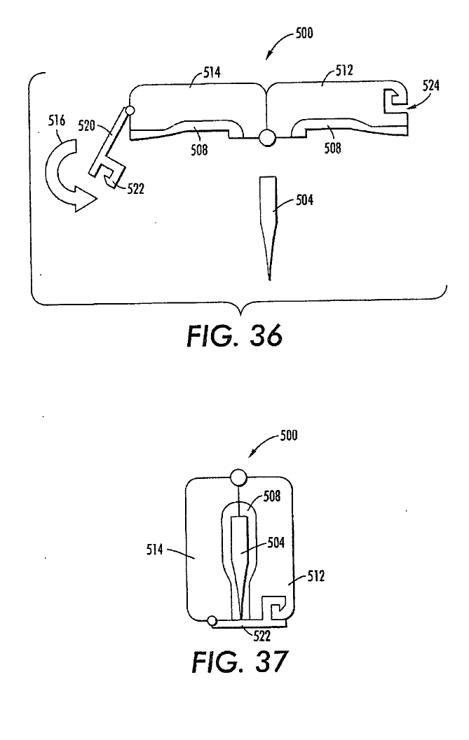

FIG. 36 is a schematic view of the blade 504 disposed above the guard assembly 500 prior to the time it is rotated in the direction of arrow 516 and locked. In the embodiment depicted in FIG. 36, the locking means is a snap buckle 520 which is hingeably attached to side 514 of guard 500 and which can lock sides 512/514 together when fastener 522 is friction fitted into receptacle 524. These and other fastening means are well known to those skilled in the art. Reference may be had, e.g., to U.S. Pat. No. D30,1566 (low profile snap buckle), U.S. Pat. No. 5,291,641 (snap buckle), U.S. Pat. No. 5,991,985 (safety snap buckle), U.S. Pat. No. 6,322,302 (snap buckle tool), and the like. The entire disclosure of each of these United States patent is hereby incorporated by reference into this specification.

FIG. 37 is an end view of the locked assembly 500.

### A Preferred Process for Making an Integral Blade Assembly

In this section of the specification, a preferred process for making an integral blade assembly is disclosed.

The blade assembly described in this section of the specification is comprised of a plastic frame that, preferably, is manufactured using high impact calcium carbonate reinforced polypropylene plastic. This high impact polypropylene, that preferably is reinforced with fine particle size calcium carbonate, provides good stiffness, heat resistance, solvent resistance, good surface quality, and good resistance to environmental stress-cracking. The material contains 40 weight percent of the filler material, has a specific gravity (as measured by ASTM D792) of 1.24, has a melt flow (as measured by ASTM d 1238) of from about 8 to about 12, and has a mold shrink (as measured by ASTM d-955) of about 0.011/inch.

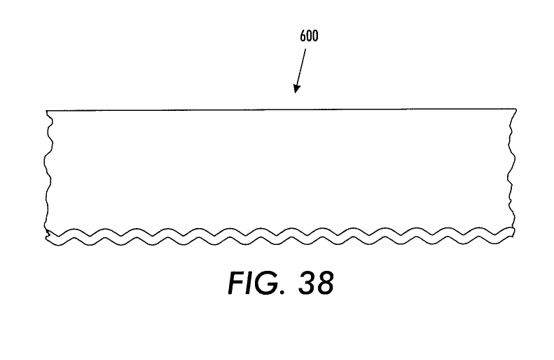

The blade used in such blade assembly is preferably manufactured from high quality stainless steel, profiled to shape, heat treated, and flat ground for a taper; thereafter, by use of a formed tool called a “crush,” a tooth profile is produced on the blade. A partial side view of such blade 600 is presented in FIG. 38.

In the process of making the blade assembly described in this section of the specification, a sleeve is preferably used. This sleeve is preferably composite plastic part that whose two halves (see halves 612 and 614) are manufactured from the same plastic material as the frame/housing and thereafter snapped together.

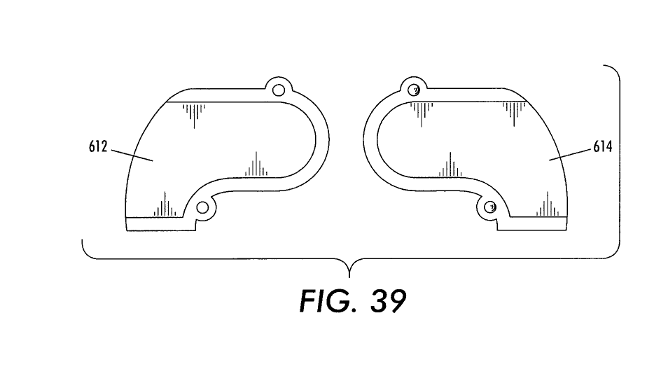

FIG. 39 is a side view of sleeve components 612 and 614 that, when snapped together, form the sleeve which receives the end of, e.g., blade 600.

The blade assembly described in this section of the specification is preferably made by an injection molding process that utilizes thermoplastic resins supplied in pellet form. These resin materials are preferably dried, melted, injected into a mold under pressure, and allowed to cool. The mold is then opened, the part removed, the mold closed and the cycle is repeated.

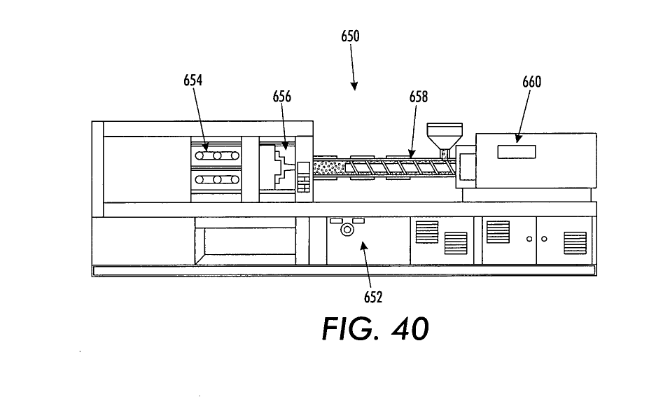

FIG. 40 is a schematic of a molding machine 650 that is comprised of a control system 652, a clamping system 654, a mold system 656, an injection system 658, and a hydraulic system 660.

Melting the plastic pellets and injecting them into the mold are the functions of the injection system 658. The rate of injection and the pressure achieved in the mold are controlled by the machine hydraulic system 660. Injection pressures range from 5,000 pounds per square inch to extremely high tonnage depending upon on the size of the mold and the plastic being injected.

The hydraulic system 660 on the injection molding machine 650 provides the power to open and close the mold, build and hold the clamping tonnage, turn the reciprocating screw, drive the reciprocating screw, and energize ejector pins and moving mold cores. A number of hydraulic components (not shown) are required to provide this power, which include pumps, valves, hydraulic motors, hydraulic fittings, hydraulic tubing, and hydraulic reservoirs.

The control system 652 provides consistency and repeatability in machine operation. It monitors and controls the processing parameters, including the temperature, pressure, injection speed, screw speed and position, and hydraulic position. The process control has a direct impact on the final part quality and the economics of the process.

The clamping system 654 opens and closes the mold, supports and carries the constituent parts of the mold, and generates sufficient force to prevent the mold from opening. Clamping force can be generated by a mechanical (toggle) lock, hydraulic lock, or a combination of the two basic types.

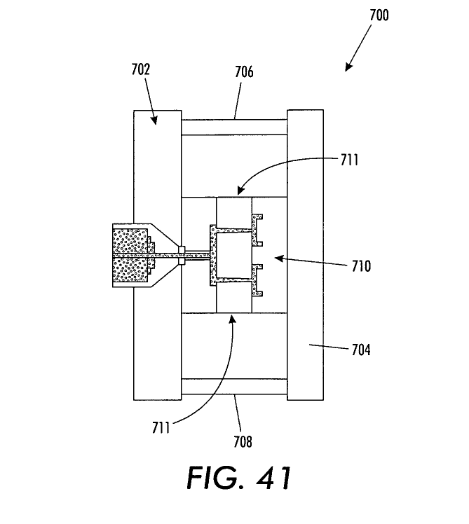

FIG. 41 is a schematic view of a mold 700 that may be used to make the blade assembly described in this portion of the specification.

A mold system is an assembly of platens and molding plates typically made of tool steel. Referring to FIG. 41, it will be seen that mold system 700 is comprised of a stationary platen 702 and movable platen 704.

The mold system shapes the plastics inside the mold cavity and ejects the molded part. The stationary platen 702 is attached to the barrel side of the machine and is connected to the moving platen 704 by the tie bars 706 and 708. The cavity plate is generally mounted on the stationary platen 702 and houses the injection nozzle. The core plate 710 moves with the moving platen 704 guided by the tie bars 706/708. Occasionally, the cavity plate is mounted to the moving platen and the core plate and a hydraulic knock-out (ejector) system is mounted to the stationary platen.

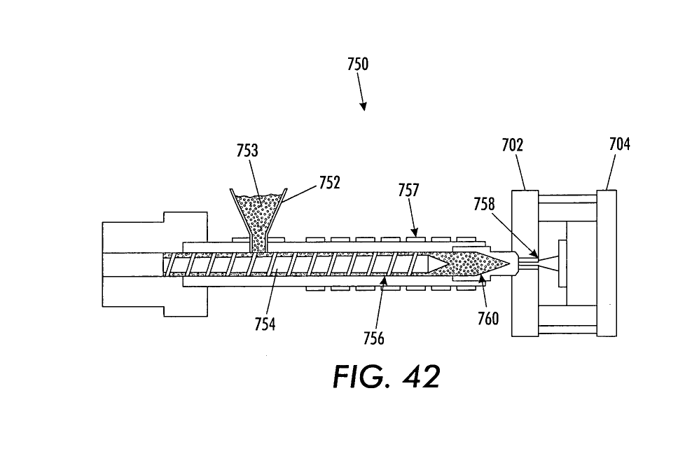

FIG. 42 is a schematic of an injection system 750 that is comprised of a hopper 752, a rotating and reciprocating screw 754 disposed within a barrel 756, and an injection nozzle 758, and an injection chamber 760. This system confines and transports the plastic as it progresses through the feeding, compressing, degassing, melting, injection, and packing stages.

The thermoplastic material used in the device 750 is preferably disposed within hopper 752 as pellets 753. Pellets 753 are preferably gravity-fed from the hopper 752 through the hopper throat into the barrel and screw assembly 756/754.

The barrel 756 the injection molding machine supports the reciprocating plasticizing screw 754. It is preferably heated by the electric heater bands 757.

The reciprocating screw 754 compresses, melts, and conveys the plastic material. In the embodiment depicted, the reciprocating screw preferably consists of three zones: a feeding zone, a compressing (or transition) zone, and a metering zone.

While the outside diameter of the screw 754 preferably remains constant, the depth of the flights on the reciprocating screw preferably decreases from the feed zone to the beginning of the metering zone. These flights compress the material against the inside diameter of the barrel 756, which creates viscous (shear) heat. This shear heat is mainly responsible for melting the material. The heater bands 757 outside the barrel 756 help maintain the material in the molten state.

In one embodiment, apparatus 750 is comprised of three or more heater bands or zones with different temperature settings.

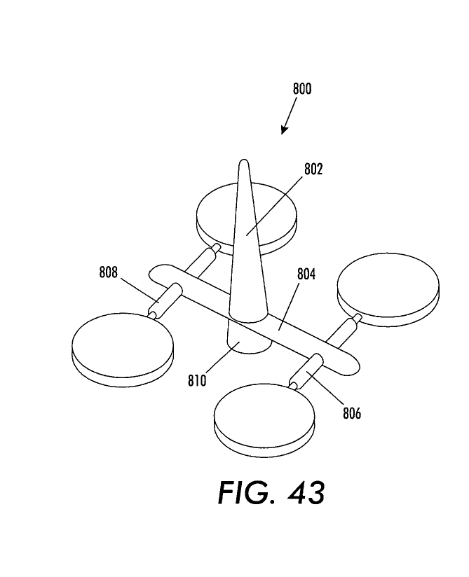

FIG. 43 is a schematic of an injection molding system 800 that is comprised of a sprue 802, a main runner 804, a branch runner 806, and gates (such as gate 808), and a cold slug well 810 adapted to fill the product cavity and produce the molded part.

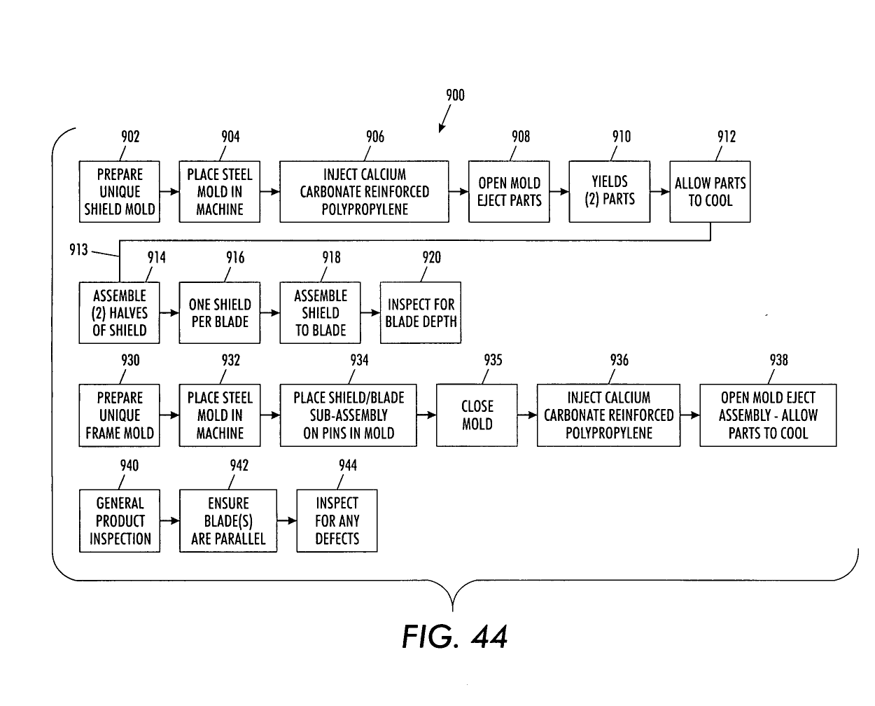

FIG. 44 is a flow diagram of a process 900 for preparing one preferred knife assembly of this invention. In step 902, a mold for the shield depicted in FIG. 39 is prepared by conventional means, and in step 904 such mold is disposed in a molding machine (such as the machine depicted in FIG. 40). Thereafter, a plastic material (such as, e.g., the calcium carbonate reinforced polypropylene discussed elsewhere in this specification [see reference to “POLIFIL RMC-40”]) is injected into the mold (see FIG. 42), preferably at a temperature of from about 325 to about 375 degrees Fahrenheit and a pressure of from about 700 to about 1400 pounds per square inch.

The molten plastic material is allowed to set in the mold for up to about 60 seconds or so; and then, in step 908, the mold is opened, the formed parts are ejected, and two parts are produced (in step 910). In one embodiment, after the mold is opened, the parts are ejected and allowed to air cool for from about 2 to about 5 minutes (see steps 910 and 912).

The parts so obtained are depicted in FIG. 39. The parts are conveyed via line 913 and, in step 914, the two halves of the assembly (parts 612 and 614) are snapped together; and one blade is selected for each such shield assembly produced (see step 916). In step 918, the shield is assembled to the blade.

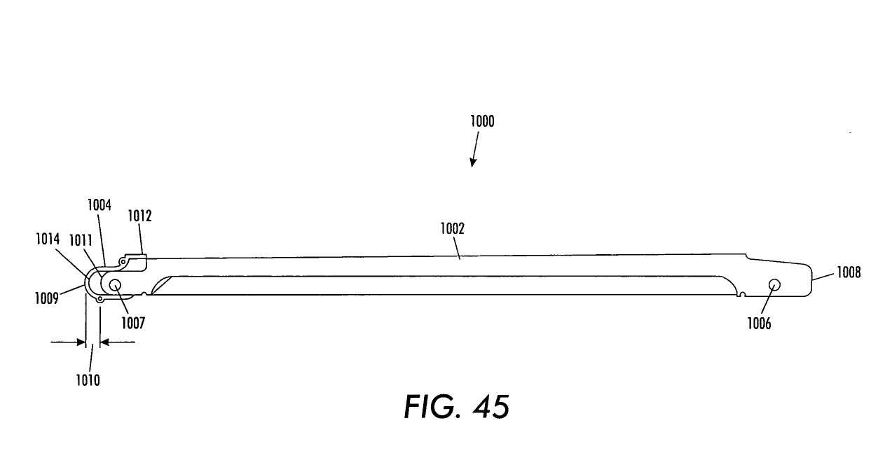

FIG. 45 is a schematic of a blade assembly 1000 comprised of a blade 1002 disposed in s shield assembly 1004. It should noted that, in the embodiment depicted, there is a hole 1006 at least end 1008 of blade 1002. Referring to FIG. 45, and the preferred embodiment depicted therein, a hole 1007 is also disposed in end 1009 of the blade 1002. Although, in reality, it is covered by the shield assembly 1004, it is shown in FIG. 45 for the sake of simplicity of representation.

Without wishing to be bound to any particular theories, applicants believe that such holes 1006 and 1007 provide means for bonding the ends of the blade 1002 to the plastic frame. It is believed that, during the injection molding process, molten plastic flows through such holes and, upon cooling, bonds to both the ends of such blade 1002 and the frame in which said blade 1002 is disposed, thereby fixedly attaching the blade 1002 at both of its ends to such frame.

One may use other means for bonding the ends of the blade 1002 to the plastic frame. Thus, e.g., one may provide one or more irregular surfaces (not shown) at the ends of such blade to which molten plastic, upon cooling, can readily adhere; when the molten plastic cools, it forms the frame bonded to the blade at both of its ends.

Referring again to FIG. 45, it is preferred that blade 1002 have at least one hole 1007. Without wishing to be bound to any particular theory, applicants believe that, during the molding process, molten plastic is disposed around and between said hole 1007 and consequently helps produce a more rigid product.

Referring again to FIG. 45, it will be seen that there is a gap 1010 between the end 1012 of the blade 1002 and the inner surface 1014 of the assembly 1004. Without wishing to be bound to any particular theory, applicants believe that this gap 1010 allows the plastic material that preferably comprises assembly 1004 to shrink during the molding process (and the cooling portion thereof) without warping the blade 1002. In one aspect of this embodiment, the gap 1010 is about 4 millimeters.

Referring again to FIG. 44, in step 918 the blade assembly is assembled in substantial accordance with FIG. 45; in step 920, the blade depth is checked.

Referring again to FIG. 45, the blade depth is the extent to which the top left edge 1012 is inserted into the assembly 1004. In one embodiment, the blade depth does not exceed about 0.32 millimeters.

Referring again to FIG. 44, in step 930, a frame mold is prepared. Referring to FIG. 41, such frame mold is identified as element 711, and it is comprised of two halves.

Referring again to FIG. 44, in step 934 the shield blade subassembly 1000 is disposed on pin in the frame mold 711. Thereafter, in step 934, the mold is closed. In step 936, the same filled plastic material that was used to make the shield assembly is preferably used, and the same injection molding conditions are preferably used.

After the filled plastic material has been injected, the part is allowed to set inside the mold for from about 1 to about 3 minutes. Thereafter, in step 938, the mold is opened, the part is ejected and allowed to cool for from about 2 to about 8 minutes.

In steps 940, 942, and 944, the molded part is inspected.

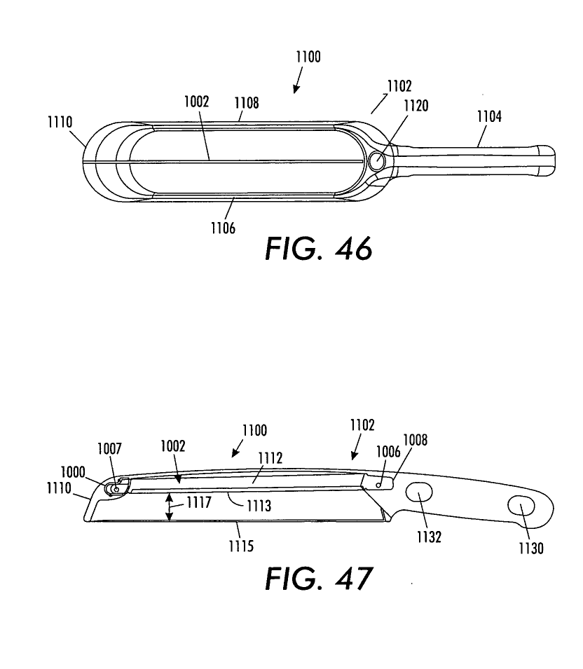

FIG. 46 is a top view of blade assembly 1100, and FIG. 47 is a side view of such blade assembly 1100. Referring to FIG. 46, it will be seen that blade assembly 1100 is comprised of blade 1002 disposed in blade shield 1000, the whole assembly disposed within a plastic enclosure 1102 that is formed in situ during the injection molding process.

Referring to FIG. 47, and in the preferred embodiment depicted therein, it will be seen that the end 1008 of blade 1002 is embedded with the plastic handle 1104 of the plastic enclosure 1102. As will be seen by reference to FIGS. 46 and 47, and in the preferred embodiment depicted, the plastic enclosure 1102 is integrally comprised of a plastic handle 1104, a first sidewall 1106, a second sidewall 1108, and an end wall 1110.

In the embodiment depicted in FIG. 47, the blade 1002 is embedded within the plastic enclosure 1102 (especially at ends 1008 and 1009), and it is completely surrounded by such plastic enclosure 1102. In one aspect of this embodiment, the ends of blade 1002 are bonded to the plastic enclosure 1102.

As used herein, the term “surrounded” refers to a blade none of whose surfaces extends above, below, or beyond the plastic enclosure.

As will be apparent, the fact that blade 1002 is completely surrounded is an important safety feature that tends to prevent a user from inadvertently cutting himself rather than a bagel.

Referring to FIG. 47, it will be seen that the top 1112 of blade 1002 is below the top surface 1114 of the plastic enclosure 1102.

The bottom 1113 of the blade 1002 is preferably above the bottom 1115 of the plastic enclosure 1102, and it is preferred that the distance 1117 between the bottom 1115 of such enclosure and the bottom 1103 of such blade is at least about 14 millimeters and often ranges from about 14 to about 24 millimeters. In another embodiment, two blades are disposed in the plastic enclosure 1102, each at a different distance 1117 from the bottom surface 1103.

Referring again to FIG. 47, the ends 1008 and 1009 are preferably embedded within and surrounded by plastic material.

Referring again to FIG. 46, and in the preferred embodiment depicted, it will be seen that plastic enclosure 1102 is comprised of a depression 1120 within which a user can insert his or her thumb while using the blade assembly. In FIG. 47, an embodiment is depicted in which the plastic enclosure 1102 is comprised of holes.

Referring again to FIG. 46, and in the embodiment depicted, it will be seen that not only is blade 1002 completely surrounded by the plastic enclosure 1102, but that is also is preferably disposed equidistantly between walls 1106 and 1108.

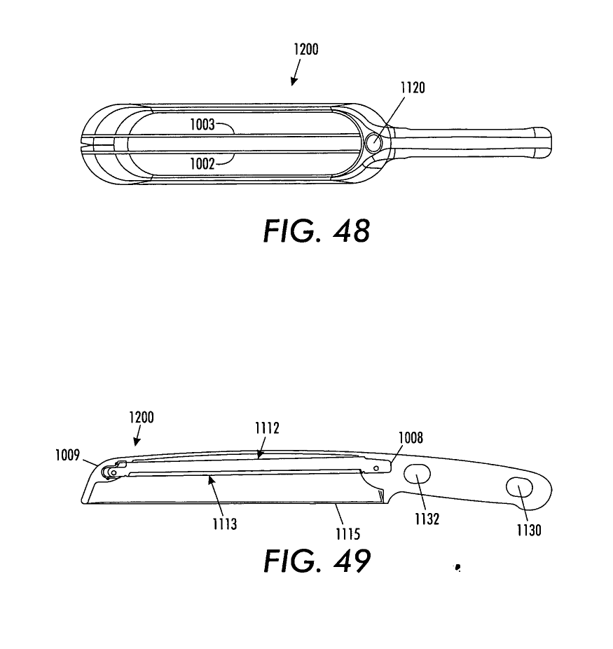

FIGS. 48 and 49 depict a two-blade assembly 1200 that is comprised of blades 1102 and 1003 and that is similar in many respects to the assembly 1100 but differs therefrom in that (a) it is comprised of at least two such blades, and (b) the blades are preferably at different distances 1117 from the bottom 115 of the plastic enclosure. This assembly is said to be “staggered,” and it provides obvious advantages to the user that are discussed elsewhere in this specification.

In the embodiment illustrated in FIGS. 48 and 49, the blades 1002 and 1103 are preferably substantially parallel to each other and to the side walls 1106 and 1108. As used herein, the term substantially parallel includes variances of from about 0 to about 3 degrees.

In the embodiment depicted in FIGS. 48 and 49, the blades 1102 and 1103 are preferably disposed equidistantly between each other and the side walls 1106 and 1108.

In one embodiment, not shown, blades 1002 and 1003 do not overlap at all. In another embodiment, depicted in FIG. 49, the blades 1002 and 1003 overlap by at least about 1 percent but less than about 50 percent.

In one embodiment, depicted, e.g., in FIGS. 48 and 49, the shield assembly 1000 is completely encased in plastic material; and such shield assembly, in turn, encloses at least a portion of the blade 1002 and/or blade 1003.

As will be apparent, the blade assembly of this invention is hermetically sealed. That is, when immersed in water, there are no cavities allowing water and/or food particles and/or other degradable material to be trapped between the blade and the plastic.

We claim:

1. A blade assembly comprised of a first blade disposed within and surrounded by a shield assembly, wherein:
(a) said shield assembly is comprised of a first sidewall and a second sidewall, a first end wall, and a second end wall, wherein:
1. said first sidewall has a first top surface and a first bottom surface,
2. said second sidewall has a second top surface and a second bottom surface, and
3. each of said first end wall and said second end wall is connected to each of said first side wall and said second side wall to form said shield assembly; and
(b) said first blade is comprised of a first proximal end and a first distal end, wherein:
1. said first proximal end is disposed within and bonded to said first side wall,
2. said first distal end is disposed within and bonded to said second side wall,
3. said first blade has a first blade top surface that does not extend above said first top surface of said first side wall or said second top surface of said second side wall, and
4. said first blade has a first blade bottom surface that does not extend below said first bottom surface of said first side wall or said second bottom surface of said second side wall.

2. The blade assembly as recited in claim 1, wherein a first hole is disposed in at least one of said first proximal end and said first distal end of said first blade.

3. The blade assembly as recited in claim 2, wherein plastic material is disposed within said first hole, and wherein said plastic material extends from said first hole to said shield assembly.

4. The blade assembly as recited in claim 1, wherein said blade assembly is comprised of a second blade disposed within and surrounded by said shield assembly.

5. The blade assembly as recited in claim 4, wherein said second blade is comprised of a second proximal end and a second distal end, wherein:
(a) said second proximal end is disposed within and bonded to said first side wall,
(b) said second distal is disposed within and bonded to said second side wall,
(c) said second blade has a second blade top surface that does not extend above said first top surface of said first side wall or said second top surface of said second side wall, and
(d) said second blade has a second blade bottom surface that does not extend below said first bottom surface of said first side wall or said second bottom surface of said second side wall.

6. The blade assembly as recited in claim 5, wherein a first hole is disposed in at least one of said first proximal end and said first distal end of said first blade.

7. The blade assembly as recited in claim 6, wherein a second hole is disposed in at least one of said second proximal end and said second distal end of said second blade.

8. The blade assembly as recited in claim 7, wherein plastic material is disposed within said first hole, and wherein said plastic material extends from said first hole to said shield assembly.

9. The blade assembly as recited in claim 8, wherein plastic material is disposed within said second hole, and wherein said plastic material extends from said second hole to said shield assembly.

10. The blade assembly as recited in claim 9, wherein said first blade is substantially parallel to said second blade.

11. The blade assembly as recited in claim 9, wherein said first blade is offset vertically from said second blade.

12. The blade assembly as recited in claim 4, wherein said shield assembly frame is comprised of at least 80 weight percent of plastic material.

13. The blade assembly as recited in claim 12, wherein plastic material is transparent plastic material.

14. The blade assembly as recited in claim 12, wherein said plastic material has a notched Izod impact strength of from about 1.0 to about 1.5 foot-pounds per inch and a water absorption of less than 5 percent.

15. The blade assembly as recited in claim 14, wherein said plastic material is a filled plastic material that is comprised of from about 10 to about 40 weight percent of inorganic filler.

16. The blade assembly as recited in claim 15, wherein said plastic material is polypropylene.

17. The blade assembly as recited in claim 16, wherein said inorganic filler is calcium carbonate.

18. The blade assembly as recited in claim 10, wherein both said first blade and said second blade are substantially parallel to both said first side wall and said second side wall.

19. The blade assembly as recited in claim 9, wherein said first blade and said second blade are staggered in position so that a leading cutting edge of one of such blades engages an item to be cut before the leading cutting edge of the other of such blades blade engages the item to be cut.

20. The blade assembly as recited in claim 14, wherein each of said first blade and said second blade is a serrated stainless steel blade.
